(19) United States
(12) Patent Application Publication
(10) Pub. No.: US 2018/0276028 A1
(43) Pub. Date: Sep. 27, 2018

(54) SINGLE-HOP TWO-PHASE TRANSACTION RESOLUTION

(71) Applicant: International Business Machines Corporation, Armonk, NY (US)

(72) Inventors: Nageswararao V. Gokavarapu, Bangalore (IN); Jithesh Moothoor, Bangalore (IN); Raghavendran Srinivasan, Bangalore (IN); Janaki Sundar, Bangalore (IN)

(21) Appl. No.: 15/464,781

(22) Filed: Mar. 21, 2017

(51) Int. Cl. G06F 9/46

(52) U.S. Cl. CPC G06F 9/466

(57) ABSTRACT

A coordinator transaction processing monitor determines a transaction coordinator identifier associated with a transaction that spans transaction processing monitors distributed between transaction processing systems. The coordinator transaction processing monitor attaches the transaction coordinator identifier as part of a transaction request of an application flow of the transaction. The transaction request from the coordinator transaction processing monitor is transmitted to a next transaction processing monitor to sequentially propagate through the transaction processing monitors. A response from the next transaction processing monitor is received. The response includes a transaction resolution endpoint identifier for each of the transaction processing monitors participating in the transaction. Transaction resolution calls of a transaction resolution flow of the transaction are sent in parallel from the coordinator transaction processing monitor to the transaction processing monitors participating in the transaction as identified based on the transaction resolution endpoint identifier of each of the participating transaction processing monitors.

### BACKGROUND

The present disclosure relates to data processing, and more specifically, to methods, systems and computer program products for single-hop two-phase transaction resolution.

Distributed Transaction Processing Monitor products (TPMs) are implemented using different software architectures to suit the services provided as well as the execution platforms. In process-based TPMs, transactions use operating system processes to run a logical unit of work (LUW). An LUW includes a sequence of operations that are acted upon as a single group that is collectively committed or rolled back (i.e., undone) together.

It is a common scenario to have a transaction span across multiple TPMs connected through traditional proprietary protocols. A TPM can act as a transaction coordinator and use a two-phase commit process to ensure data consistency with the recoverable resources associated with the transaction. When there is more than one TPM involved in an LUW, the TPM that initiates the transaction assumes the responsibility of a coordinator and the other TPMs act as participants. The coordinating TPM usually controls the final resolution of a transaction that spans across multiple TPMs and resource managers connected to participant TPMs.

As the number of transactional processing systems involved in an LUW increases, the time taken for transaction resolution and transaction recovery will increase. Every TPM usually treats the requester TPM as the coordinator in a synchronously processed transaction. When the TPM coordinator issues a PREPARE, COMMIT, or ROLLBACK operation command during transaction resolution, every TPM involved in the LUW has to prepare for transaction resolution with its participants. Transaction participants can be either a resource manager or any other interconnected TPM. Similarly, if any intermediate TPM fails or crashes in a chain of TPMs, recovery should happen at every TPM involved in the LUW. A crash in an intermediate TPM handling a transaction can even result in some further TPMs waiting for its coordinator response indefinitely.

### SUMMARY

In accordance with an embodiment, a method for single-hop two-phase transaction resolution is provided. The method may include determining, by a coordinator transaction processing monitor, a transaction coordinator identifier associated with a transaction that spans a plurality of transaction processing monitors distributed between a plurality of transaction processing systems. The coordinator transaction processing monitor attaches the transaction coordinator identifier as part of a transaction request of an application flow of the transaction. The transaction request from the coordinator transaction processing monitor is transmitted to a next transaction processing monitor to sequentially propagate through the transaction processing monitors. A response from the next transaction processing monitor is received. The response includes a transaction resolution endpoint identifier for each of the transaction processing monitors participating in the transaction. A plurality of transaction resolution calls of a transaction resolution flow of the transaction is sent in parallel from the coordinator transaction processing monitor to the transaction processing monitors participating in the transaction as identified based on the transaction resolution endpoint identifier of each of the transaction processing monitors participating in the transaction.

In another embodiment, a system may include a memory having computer readable instructions and a processor for executing the computer readable instructions. The computer readable instructions can include determining, by a coordinator transaction processing monitor, a transaction coordinator identifier associated with a transaction that spans a plurality of transaction processing monitors distributed between a plurality of transaction processing systems. The computer readable instructions can also include attaching, by the coordinator transaction processing monitor, the transaction coordinator identifier as part of a transaction request of an application flow of the transaction and transmitting the transaction request from the coordinator transaction processing monitor to a next transaction processing monitor to sequentially propagate through the transaction processing monitors. A response can be received from the next transaction processing monitor. The response can include a transaction resolution endpoint identifier for each of the transaction processing monitors participating in the transaction. The computer readable instructions can further include sending a plurality of transaction resolution calls of a transaction resolution flow of the transaction in parallel from the coordinator transaction processing monitor to the transaction processing monitors participating in the transaction as identified based on the transaction resolution endpoint identifier of each of the transaction processing monitors participating in the transaction.

In another embodiment, a computer program product may include a computer readable storage medium having program instructions embodied therewith. The program instructions executable by a processor to cause the processor to perform determining, by a coordinator transaction processing monitor, a transaction coordinator identifier associated with a transaction that spans a plurality of transaction processing monitors distributed between a plurality of transaction processing systems. The coordinator transaction processing monitor attaches the transaction coordinator identifier as part of a transaction request of an application flow of the transaction. The transaction request from the coordinator transaction processing monitor is transmitted to a next transaction processing monitor to sequentially propagate through the transaction processing monitors. A response from the next transaction processing monitor is received. The response includes a transaction resolution endpoint identifier for each of the transaction processing monitors participating in the transaction. A plurality of transaction resolution calls of a transaction resolution flow of the transaction is sent in parallel from the coordinator transaction processing monitor to the transaction processing monitors participating in the transaction as identified based on the transaction resolution endpoint identifier of each of the transaction processing monitors participating in the transaction.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system for a traditional transaction resolution flow;

FIG. 3 is a block diagram illustrating a computing system in accordance with an exemplary embodiment;

FIG. 4 is a table illustrating a transaction resolution record in accordance with an exemplary embodiment;

FIG. 5 is a table illustrating a request payload in accordance with an exemplary embodiment;

FIG. 6 is a data flow diagram for single-hop two-phase transaction resolution in accordance with an exemplary embodiment;

FIG. 7 is a flow diagram of a transactional application execution request flow in accordance with an exemplary embodiment;

FIG. 8 is a flow diagram of a transactional application execution response flow in accordance with an exemplary embodiment;

FIG. 9 is a flow diagram of a transaction resolution flow in accordance with an exemplary embodiment; and

FIG. 10 is a flow diagram of a method for single-hop two-phase transaction resolution in accordance with an exemplary embodiment.

### DETAILED DESCRIPTION

In accordance with exemplary embodiments of the disclosure, methods, systems and computer program products for single-hop two-phase transaction resolution are provided. The systems and methods described herein are directed to reducing the complexity of transaction resolution by reorganizing a synchronization point flow pattern in a network of serially interconnected transaction processing monitors (TPMs) spanning across multiple levels. A transaction recovery resolution flow can be sped up in case of a TPM participant failure in a network of interconnected TPMs. The methods and systems described herein can also track all the participating TPMs during transaction execution and dynamically arrive at the transaction resolution flow.

In a transaction that is spans across multiple TPMs, the transaction execution may include of two types of flows across TPMs. The first type of flow is an application request flow, and the second type of flow is a transaction resolution flow. In the methods and systems described herein, during the application request flow, the coordinator TPM associates its information with a transaction coordinator identifier, such as a coordinator indication flag, as a part of the transaction request (e.g., within a transaction request payload) when it routes the request to the next TPM. Branch TPMs that participate in the transaction can each attach transaction resolution endpoint details including a transaction identifier (XID) branch ID used for dynamic registrations as part of a response, for instance, in a response payload. Preceding TPMs can read the transaction resolution endpoint details including the XID branch ID used for dynamic extended architecture (XA) registrations from all subsequent TPMs, and each participating TPM attaches the information in its response payload to its preceding TPM. This flow continues until the response reaches back to the TPM coordinator. In embodiments, the TPM coordinator collects information about all the TPM participants involved in the transaction, which may not be known to the TPM coordinator prior to transmitting the application request flow. Using this data, the TPM coordinator directly contacts the participating TPMs in parallel for the transaction resolution flow. Though the participating TPMs exist at multiple levels in different transaction branches of a global transaction, the TPM coordinator can treat all the TPMs as its direct participant TPM and send the transaction resolution calls in parallel to all the TPMs using the transaction resolution endpoint details and XID branch ID collected from the response payload during application flow. This method enables quicker transaction resolution compared to traditional transactional resolution and thereby improves networked system performance.

In some embodiments, the technical advantages for the systems and methods described herein include the knowledge of the TPM coordinator of all the TPMs involved in the global transaction, which helps the TPM coordinator facilitate a more efficient transaction resolution. The TPM coordinator's centralized transaction resolution reduces the possibility of transactions getting stuck indefinitely when a TPM goes down during resolution. The TPM coordinator can send the resolution calls in parallel to all participating TPMs. The resolution happens quicker compared to traditional methods, and resources are released sooner. The TPM coordinator may recognize participant failures much earlier, which enables it to process transaction resolution procedures to other TPM participants involved in the transaction.

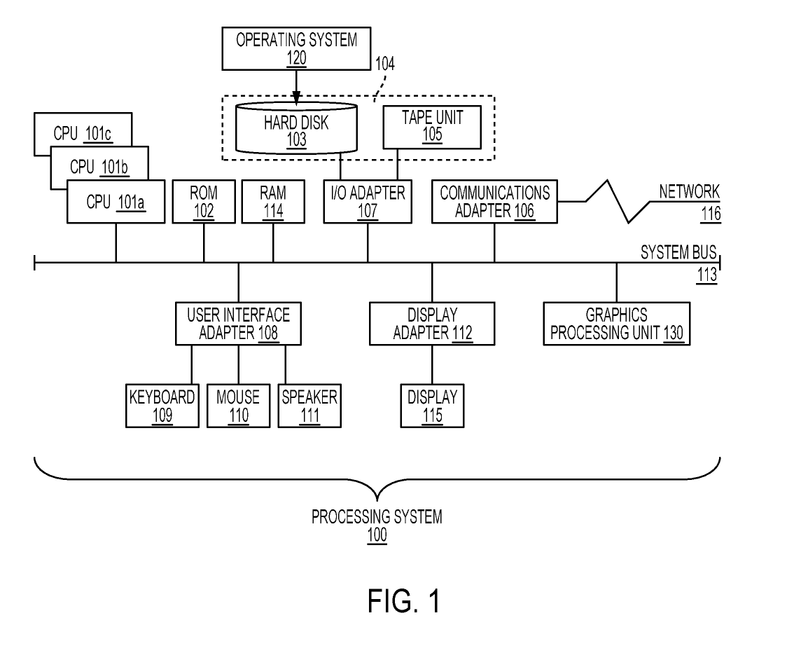

FIG. 1 further depicts an input/output (I/O) adapter 107 and a communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A communications adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnect to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

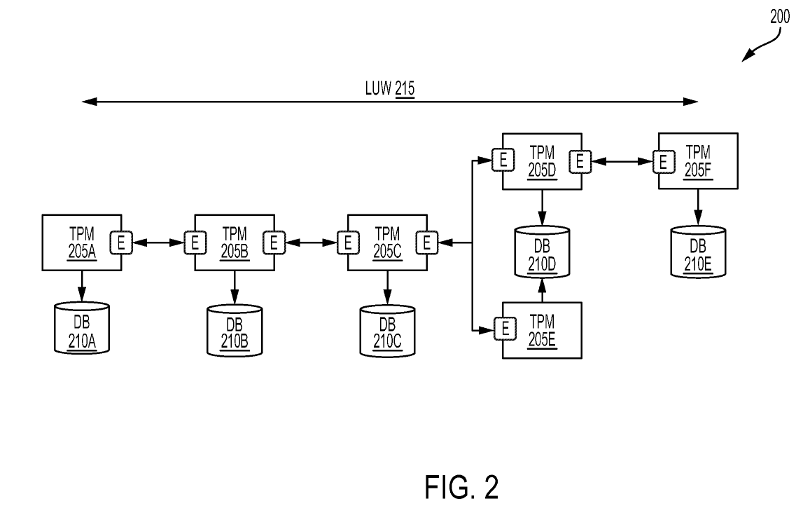

Now referring to FIG. 2, a block diagram illustrating a computing system 200 for a traditional transaction resolution flow is depicted. In a typical complex enterprise architecture, multiple TPMs may be interconnected with proprietary protocols. As technology becomes increasingly sophisticated, applications may execute in one TPM, which may be integrated with other services running on other TPMs. As a result, the number of TPMs involved in a Logical Unit of Work (LUW) or transactions increase, which may in turn increase the response time for transaction resolution. When a transaction for a LUW is spanned across multiple TPMs, a coordinator TPM 205A that initiates the transaction is responsible for resolving the outcome of transaction resolution with its associated database 210A as well as the entire LUW that is spread across TPM 205B, TPM 205C, TPM 205D, TPM 205E, and TPM 205F and the data that each TPM controls as a part of its transaction execution (e.g., databases 210B, 210C, 210D, and 210E). If a transaction is spanned across multiple TPMs, the coordinator TPM 205A uses a global transaction mechanism across TPMs 205B-F to achieve a single LUW. The global transaction execution includes two types of flows across TPMs 205A-F involved in the transaction. The first flow type is an application flow, during which higher-level application logic executes in the TPMs 205A-F. The second type of flow is a transaction resolution flow, during which the TPM coordinator 205A decides to COMMIT or ROLLBACK the work after confirming the readiness of each participating TPM 205B-F. A global transaction can be uniquely identified by a Global Transaction Identifier (GTRId) which is propagated across TPMs 205B-F. The individual TPMs 205B-F can attach a branch identifier that uniquely identifies the transaction. The combination of GTRId and Branch identifier can uniquely identify a global transaction in across TPMs 205A-F.

As depicted in FIG. 2, a LUW 215 can span across multiple TPMs 205A-F, the transaction resolution flow can be sent to all the TPM participants involved in the transaction. The TPMs 205A-F can communicate using a transaction endpoint (e.g., denoted in FIG. 2 as “E”), which may include an Internet protocol (IP) address and a port with other TPMs 205A-F. Transaction resolution involves multiple syncpoint flows for achieving the global transaction across TPMs 205A-F. When coordinator TPM 205A sends a transaction resolution flow to its subsequent interconnected TPMs 205B-F and resource managers, the TPMs 205B-F send the same transaction resolution flow to its subsequent interconnected TPMs 205B-F and resource managers. The flow continues until it reaches the last TPM 205F in a transaction branch involved in the global transaction. The TPMs 205A-F collect the response from its subsequent interconnected TPMs 205A-F and resource managers, decide the response, and send back the response to its preceding TPM 205A-F. The response flow continues from all transaction branches involved in a global transaction until the response reaches the coordinator TPM 205A.

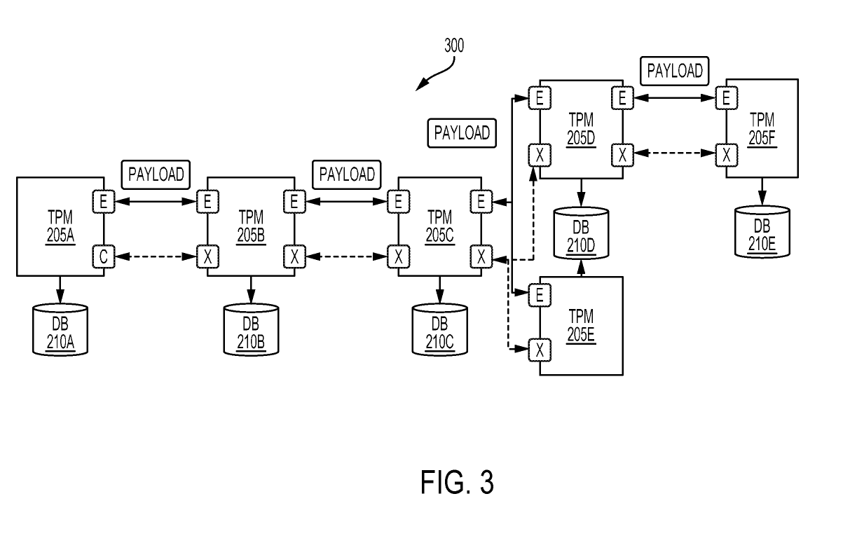

FIG. 3 is a block diagram illustrating a computing system 300 in accordance with an exemplary embodiment. In some embodiments, each TPM 205A-F can include an additional transaction resolution endpoint (denoted in FIG. 3 by “X”). During the application flow, the TPMs 205A-F will use the transaction application endpoint (E) to communicate with other TPMs 205A-F. In some embodiments, the transaction application request flow is the same as traditional methods with additional information about the coordinator added to a request payload. Application execution continues in same manner. When application execution is completed, and during the application response flow, each TPM 205B-F can attach an additional transactional resolution record along with the response payload. The TPMs 205A-F wait for transaction resolution response on the transaction resolution endpoint.

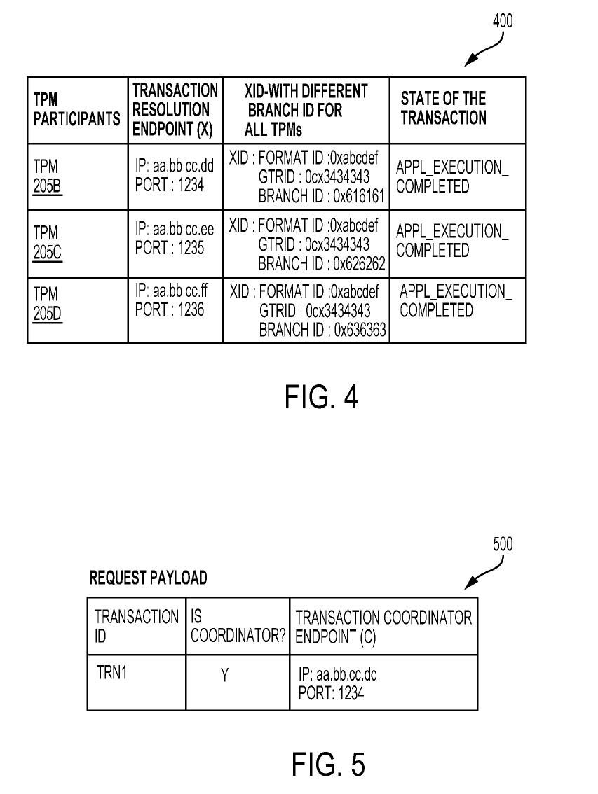

FIG. 4 is a table illustrating a transaction resolution record 400 in accordance with an exemplary embodiment. In some embodiments, the transaction resolution record 400, as depicted in FIG. 4, can include a TPM name, transaction resolution endpoint (e.g., IP address and port), transaction ID (e.g., XID format ID, GTRId, and branch ID), and the state of the transaction. The transaction ID (e.g., the GTRId) can be the same in all TPMs 205A-F for a transaction instance from TPM coordinator 205A onward and the branch IDs are unique for each TPM 205B-F. The transaction state can be maintained in the transaction resolution record 400. This state information may be used by the TPM coordinator 205A to make decisions on transaction resolution. Each TPM 205A-F can read the transaction resolution record 400 in the payload from all its subsequent TPMs 205B-F and attaches the information in its application response payload to its preceding TPM 205A-F. This flow continues until the response reaches the TPM coordinator 205A. Based on receiving the response, the TPM coordinator 205A will have information about all the TPM 205B-F participants involved in the transaction and also the state of the transaction. Using this data, the TPM coordinator 205A can directly contact the participating TPMs 205B-F for the transaction resolution flow. The payload for transaction resolution can be maintained in a table referred as a Transaction Participant Resolution End Point (TPREP) table in a physical disk, for instance. The data in the TPREP can be used to resolve transactions during recovery after a TPM crash.

FIG. 5 is a table illustrating a request payload 500 in accordance with an exemplary embodiment. The request payload 500 is sent from the coordinator TPM 205A to the participating TPMs 205B-F and may include a transaction ID (e.g., TRN1), a transaction coordinator identifier such as a transaction coordinator flag, and a transaction coordinator endpoint (C) identifier such as an IP address and port number.

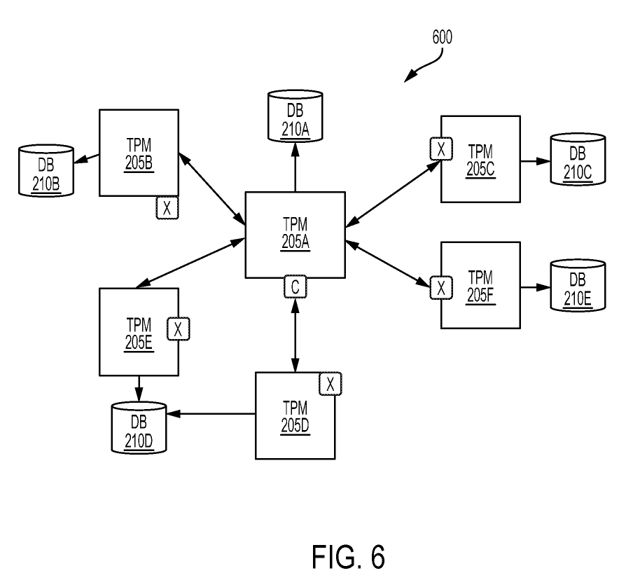

FIG. 6 is a data flow diagram 600 for single-hop two-phase transaction resolution in accordance with an exemplary embodiment. The participating TPMs 205A-F exist at multiple levels in different transaction branches of a global transaction and all TPMs 205B-F are not directly connected to the TPM coordinator 205A during the application flow as depicted in the examples of FIGS. 2 and 3. The coordinator TPM 205A forms a transaction resolution model centralized around the coordinator TPM 205A with all the participating TPMs 205B-F as its direct branches, as shown in FIG. 6. The TPM coordinator 205A can send transaction resolution calls in parallel to all the participating TPMs 205B-F. FIG. 6 depicts a configuration that enables quicker transaction resolution compared to traditional transactional resolution as syncpoint resolution operation happens in parallel. As the transaction resolution records are collected during the application execution flow, the coordinator TPM 205A can use this data for operations such as PREPARE, COMMIT, and ROLLBACK operations. The method eliminates delays involved due to multiple intersystem communication operations and also makes quicker transaction COMMIT/ROLLBACK decisions as the participating TPM 205B-F failure can detected directly by the coordinator TPM 205A. In some embodiments, a table of all the TPMs and its listener ports can be maintained at a location accessible by the coordinator TPM 205A and may also be accessible to participating TPMs 205B-F in the network to reduce the response payload size.

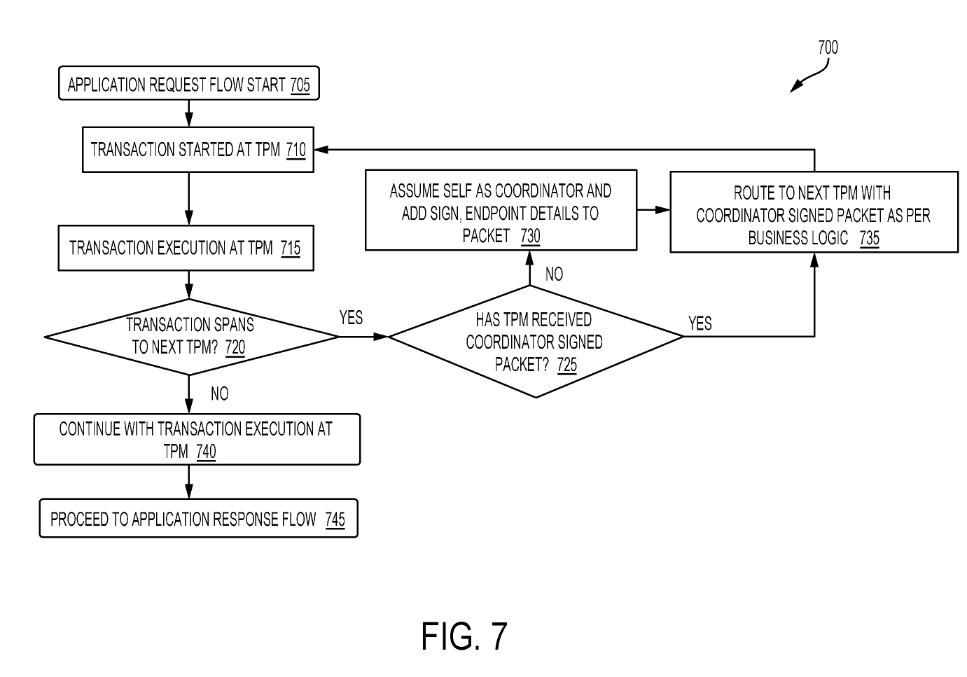

FIG. 7 depicts a method 700 of transactional application execution request flow in accordance with an exemplary embodiment. At block 705, an application request flow starts. At block 710, a transaction is started at a TPM such as coordinator TPM 205A. At block 715, transaction execution starts at a TPM such as coordinator TPM 205A. At block 720, the coordinator TPM determines whether the transaction spans to a next TPM such as TPM 205B. If the transaction spans to a next TPM, then at block 725 it is determined whether the TPM has received a coordinator signed packet, such as the transaction coordinator identifier in request payload 500. If the TPM has not received the coordinator signed packet, then at block 730, the TPM can assume that it is the coordinator TPM 205A and adds the transaction coordinator flag and transaction coordinator endpoint details to a request. At block 735, after block 730 or after the TPM received a coordinator signed packet, the request with the coordinator signed packet including request payload 500 is routed to the next TPM (e.g., TPM 205B-F) as per application logic (e.g., sequentially as depicted in FIGS. 2 and 3), and flow returns to block 710. At block 720, if the transaction does not span to a next TPM, then at block 740, transaction execution continues at the TPM, and the TPM can proceed with an application response flow at block 745.

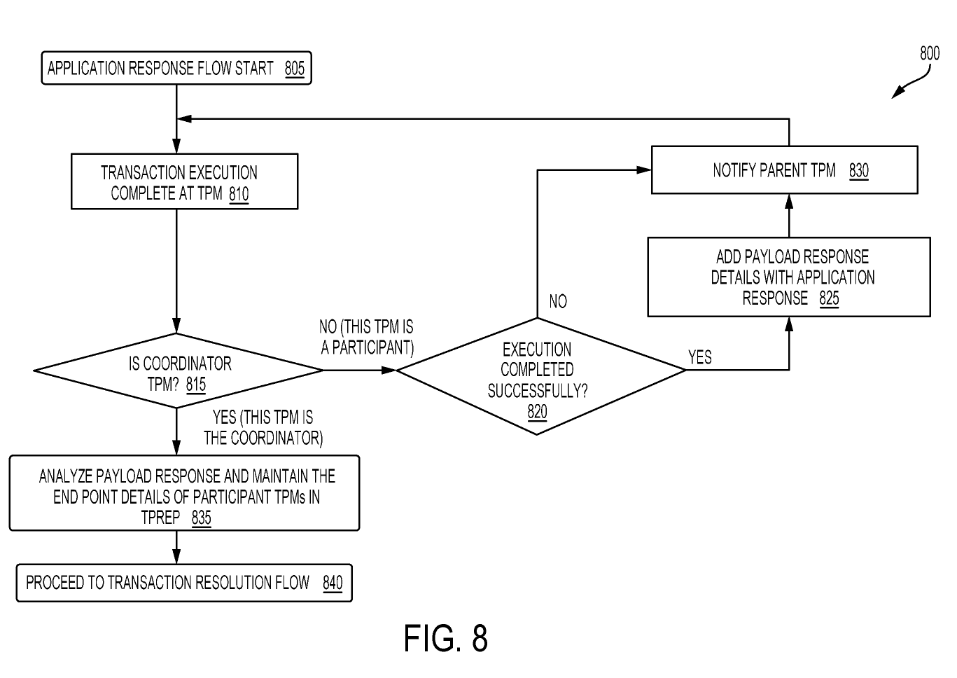

FIG. 8 depicts a method 800 of transactional application execution response flow in accordance with an exemplary embodiment. At block 805, an application response flow starts. At block 810, transaction execution completes at a TPM 205A-F. At block 815, the TPM determines whether it is the coordinator TPM 205A. If the TPM is a participant TPM 205B-F, the TPM 205B-F determines whether execution has completed successfully at block 820. If execution has completed successfully, payload response details can be added with the application response such as the transaction resolution record 400 of FIG. 4. The parent (e.g., upstream) TPM 205A-E is notified at block 830 whether or not execution completed successfully and flow returns to block 810. If at block 815, the TPM is the coordinator TPM 205A, the TPM 205A analyzes the payload response and maintains the end point details of participant TPMs 205B-F in TPREP at block 835 and TPM proceeds to a transaction resolution flow at block 840.

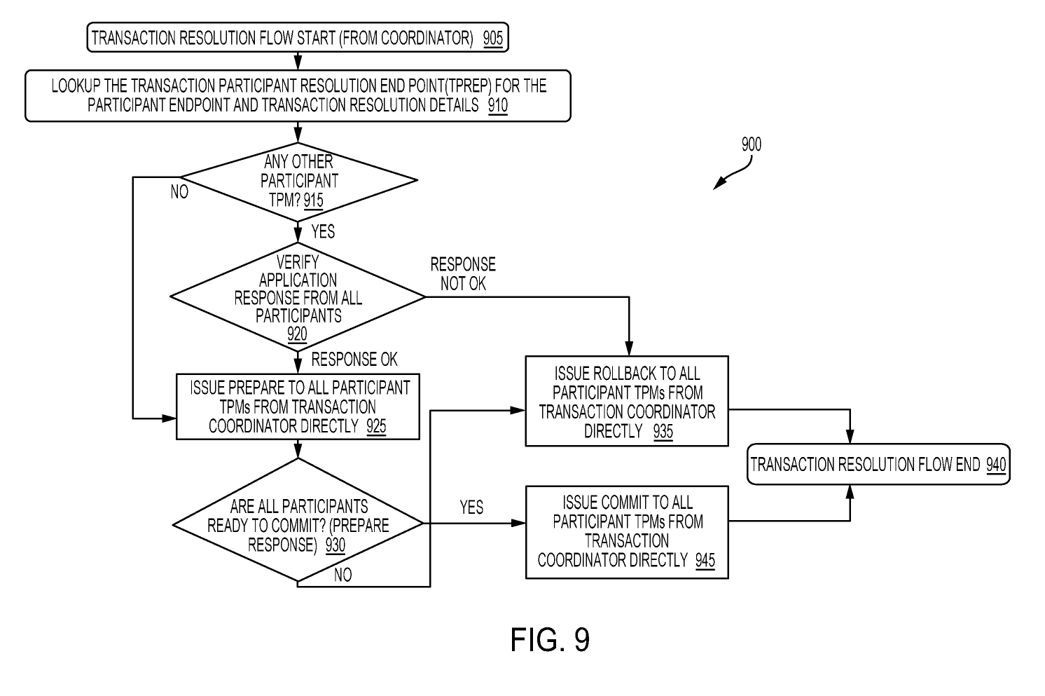

FIG. 9 depicts a method 900 of a transaction resolution flow in accordance with an exemplary embodiment. At block 905, the transaction resolution flow starts from the coordinator TPM 205A. At block 910, the coordinator TPM 205A can look up the transaction participant resolution endpoint (TPREP) data for the participant endpoints and transaction resolution details for TPMs 205B-F. At block 915, the coordinator TPM 205A determines whether there are any other participant TPMs for the transaction. If there are, at block 920, the coordinator TPM verifies an application response has been received from all participant TPMs 205B-F and issues a PREPARE operation to all participant TPMs 205B-F directly in parallel at block 925. After issuing the PREPARE, at block 930, the coordinator TPM 205A determines whether all participant TPMs 205B-F are ready to commit (i.e., in response to the PREPARE operation). If all participant TPMs 205B-F are not ready, the coordinator TPM 205A can issue a ROLLBACK operation to all participant TPMs 205B-F directly in parallel at block 935, and the transaction resolution flow ends at block 940. If all participant TPMs 205B-F are ready at block 930, the coordinator TPM 205A can issue a COMMIT operation to all participant TPMs 205B-F directly in parallel at block 945, and the transaction resolution flow ends at block 940.

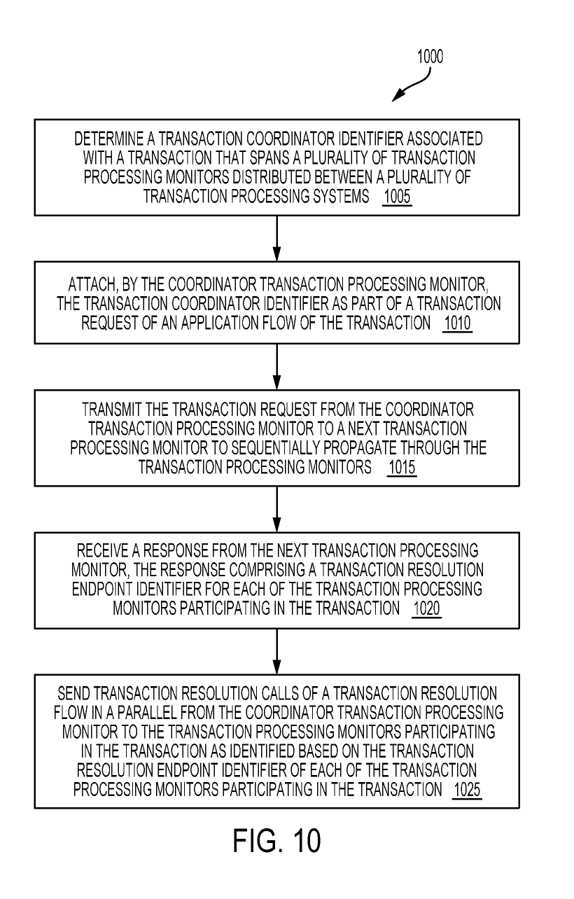

FIG. 10 depicts a method 1000 for single-hop two-phase transaction resolution in accordance with an exemplary embodiment. The method 1000 is described in reference to FIGS. 1-9 and may include additional steps and conditions beyond those depicted in FIG. 10. At block 1005, a coordinator TPM 205A determines a transaction coordinator identifier (e.g., a transaction coordinator flag and transaction coordinator endpoint details for a transaction ID) associated with a transaction that spans a plurality of TPMs 205A-F distributed between a plurality of transaction processing systems (e.g., one or more networked computer systems). At block 1010, the coordinator TPM 205A attaches the transaction coordinator identifier as part of a transaction request of an application flow of the transaction, such as request payload 500. At block 1015, the transaction request from the coordinator TPM 205A is transmitted to a next TPM 205B to sequentially propagate through the TPMs 205C-F in sequences depicted in FIGS. 2 and 3. At block 1020, a response from the next TPM 205B is received, such as transaction resolution record 400. The response can include a transaction resolution endpoint identifier (e.g., XID and IP address/port information) for each of the TPMs 205B-F participating in the transaction. At block 1025, a plurality of transaction resolution calls of a transaction resolution flow of the transaction is sent in parallel from the coordinator TPM 205A to the TPMs 205B-F participating in the transaction as identified based on the transaction resolution endpoint identifier of each of the TPMs 205B-F participating in the transaction, for instance, according to data flow diagram 600.

The transaction coordinator identifier can include a transaction coordinator endpoint address and a coordinator indication flag. The transaction resolution endpoint identifier of each of the TPMs 205B-F participating in the transaction can include a branch identifier that is unique to one of the TPMs 205B-F. The transaction resolution endpoint identifier of each of the TPMs 205B-F participating in the transaction can include a transaction resolution endpoint address. The response can include a global transaction identifier shared by all of the TPMs 205B-F participating in the transaction. An endpoint address of fewer than all of the TPMs 205B-F participating in the transaction may be known by the coordinator TPM 205A prior to transmitting the transaction request during the application flow of the transaction.

The coordinator TPM 205A can determine a next coordinated operation to be performed by each of the TPMs 205B-F participating in the transaction based on the response. A commit operation can be issued from the coordinator TPM 205A in parallel to all of the TPMs 205B-F participating in the transaction based on determining that all of the TPMs 205B-F participating in the transaction are ready to commit as depicted in the example of FIG. 9. Similarly, a rollback operation can be issued from the coordinator TPM 205A in parallel to all of the TPMs 205B-F participating in the transaction based on determining that at least one of the TPMs 205B-F participating in the transaction is not ready to commit. Alternate operations can also be supported across the TPMs 205A-F according to embodiments, e.g., prepare operations.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a coordinator transaction processing monitor, a transaction coordinator identifier associated with a transaction that spans a plurality of transaction processing monitors distributed between a plurality of transaction processing systems;
attaching, by the coordinator transaction processing monitor, the transaction coordinator identifier as part of a transaction request of an application flow of the transaction;
transmitting the transaction request from the coordinator transaction processing monitor to a next transaction processing monitor to sequentially propagate through the transaction processing monitors;
receiving a response from the next transaction processing monitor, the response comprising a transaction resolution endpoint identifier for each of the transaction processing monitors participating in the transaction; and
sending a plurality of transaction resolution calls of a transaction resolution flow of the transaction in parallel from the coordinator transaction processing monitor to the transaction processing monitors participating in the transaction as identified based on the transaction resolution endpoint identifier of each of the transaction processing monitors participating in the transaction.

2. The computer-implemented method of claim 1, wherein the transaction coordinator identifier comprises a transaction coordinator endpoint address and a coordinator indication flag.

3. The computer-implemented method of claim 1, wherein the transaction resolution endpoint identifier of each of the transaction processing monitors participating in the transaction comprises a branch identifier that is unique to one of the transaction processing monitors.

4. The computer-implemented method of claim 3, wherein the transaction resolution endpoint identifier of each of the transaction processing monitors participating in the transaction further comprises a transaction resolution endpoint address.

5. The computer-implemented method of claim 1, wherein the response further comprises a global transaction identifier shared by all of the transaction processing monitors participating in the transaction.

6. The computer-implemented method of claim 1, wherein an endpoint address of fewer than all of the transaction processing monitors participating in the transaction is known by the coordinator transaction processing monitor prior to transmitting the transaction request during the application flow of the transaction.

7. The computer-implemented method of claim 1, further comprising:
determining, by the coordinator transaction processing monitor, a next coordinated operation to be performed by each of the transaction processing monitors participating in the transaction based on the response;
issuing a commit operation from the coordinator transaction processing monitor in parallel to all of the transaction processing monitors participating in the transaction based on determining that all of the transaction processing monitors participating in the transaction are ready to commit; and
issuing a rollback operation from the coordinator transaction processing monitor in parallel to all of the transaction processing monitors participating in the transaction based on determining that at least one of the transaction processing monitors participating in the transaction is not ready to commit.

8. A system, comprising:
a memory having computer readable instructions; and
a processor for executing the computer readable instructions comprising:
determining, by a coordinator transaction processing monitor, a transaction coordinator identifier associated with a transaction that spans a plurality of transaction processing monitors distributed between a plurality of transaction processing systems;
attaching, by the coordinator transaction processing monitor, the transaction coordinator identifier as part of a transaction request of an application flow of the transaction;
transmitting the transaction request from the coordinator transaction processing monitor to a next transaction processing monitor to sequentially propagate through the transaction processing monitors;
receiving a response from the next transaction processing monitor, the response comprising a transaction resolution endpoint identifier for each of the transaction processing monitors participating in the transaction; and
sending a plurality of transaction resolution calls of a transaction resolution flow of the transaction in parallel from the coordinator transaction processing monitor to the transaction processing monitors participating in the transaction as identified based on the transaction resolution endpoint identifier of each of the transaction processing monitors participating in the transaction.

9. The system of claim 8, wherein the transaction coordinator identifier comprises a transaction coordinator endpoint address and a coordinator indication flag.

10. The system of claim 8, wherein the transaction resolution endpoint identifier of each of the transaction processing monitors participating in the transaction comprises a branch identifier that is unique to one of the transaction processing monitors.

11. The system of claim 10, wherein the transaction resolution endpoint identifier of each of the transaction processing monitors participating in the transaction further comprises a transaction resolution endpoint address.

12. The system of claim 8, wherein the response further comprises a global transaction identifier shared by all of the transaction processing monitors participating in the transaction.

13. The system of claim 8, wherein an endpoint address of fewer than all of the transaction processing monitors participating in the transaction is known by the coordinator transaction processing monitor prior to transmitting the transaction request during the application flow of the transaction.

14. The system of claim 8, wherein the computer readable instructions further comprise:
determining, by the coordinator transaction processing monitor, a next coordinated operation to be performed by each of the transaction processing monitors participating in the transaction based on the response;
issuing a commit operation from the coordinator transaction processing monitor in parallel to all of the transaction processing monitors participating in the transaction based on determining that all of the transaction processing monitors participating in the transaction are ready to commit; and
issuing a rollback operation from the coordinator transaction processing monitor in parallel to all of the transaction processing monitors participating in the transaction based on determining that at least one of the transaction processing monitors participating in the transaction is not ready to commit.

15. A computer program product comprising a computer readable storage medium having program instructions embodied therewith, the program instructions executable by a processor to cause the processor to perform:
determining, by a coordinator transaction processing monitor, a transaction coordinator identifier associated with a transaction that spans a plurality of transaction processing monitors distributed between a plurality of transaction processing systems;
attaching, by the coordinator transaction processing monitor, the transaction coordinator identifier as part of a transaction request of an application flow of the transaction;
transmitting the transaction request from the coordinator transaction processing monitor to a next transaction processing monitor to sequentially propagate through the transaction processing monitors;
receiving a response from the next transaction processing monitor, the response comprising a transaction resolution endpoint identifier for each of the transaction processing monitors participating in the transaction; and
sending a plurality of transaction resolution calls of a transaction resolution flow of the transaction in parallel from the coordinator transaction processing monitor to the transaction processing monitors participating in the transaction as identified based on the transaction resolution endpoint identifier of each of the transaction processing monitors participating in the transaction.

16. The computer program product of claim 15, wherein the transaction coordinator identifier comprises a transaction coordinator endpoint address and a coordinator indication flag.

17. The computer program product of claim 15, wherein the transaction resolution endpoint identifier of each of the transaction processing monitors participating in the transaction comprises a branch identifier that is unique to one of the transaction processing monitors.

18. The computer program product of claim 17, wherein the transaction resolution endpoint identifier of each of the transaction processing monitors participating in the transaction further comprises a transaction resolution endpoint address.

19. The computer program product of claim 15, wherein the response further comprises a global transaction identifier shared by all of the transaction processing monitors participating in the transaction.

20. The computer program product of claim 15, the program instructions further cause the processor to perform:
determining, by the coordinator transaction processing monitor, a next coordinated operation to be performed by each of the transaction processing monitors participating in the transaction based on the response;
issuing a commit operation from the coordinator transaction processing monitor in parallel to all of the transaction processing monitors participating in the transaction based on determining that all of the transaction processing monitors participating in the transaction are ready to commit; and
issuing a rollback operation from the coordinator transaction processing monitor in parallel to all of the transaction processing monitors participating in the transaction based on determining that at least one of the transaction processing monitors participating in the transaction is not ready to commit.
